(19) United States
(12) Patent Application Publication
(10) Pub. No.: US 2005/0093711 A1
(43) Pub. Date: May 5, 2005

(54) Programmable logic controller tone generating method and apparatus

(75) Inventors: Angelo S. Arcaria, Wethersfield, CT (US); Kenneth R. Taylor, Ivoryton, CT (US)

Correspondence Address: BAKER & HOSTETLER LLP;Suite 1100, Washington Square, 1050 Connecticut Avenue, N.W., Washington, DC, 20036, US

(73) Assignee: Edwards Systems Technology, Inc.

(21) Appl. No.: 10/692,689

(22) Filed: Oct. 27, 2003

(51) Int. Cl. G08B 25/08

(52) U.S. Cl. 340/692; 340/384.7

(57) ABSTRACT

A programmable logic controller (PLC) having an audio generator operably connected to the PLC is configured to output an audio signal generated by the audio generator. A method of generating an audio tone and/or prerecorded voice includes interfacing control circuitry with a programmable logic controller and an audio generator, generating an audio signal with the audio generator, and outputting the audio signal from the programmable logic controller.

### FIELD OF THE INVENTION

The present invention relates generally to programmable logic controllers or (PLCs). More particularly, the present invention relates to a PLC with a tone generator having a tone output incorporated and into part of the PLC.

### BACKGROUND OF THE INVENTION

Many audio systems have a plurality of speakers that are connected together and are controlled by a single controller. Some examples of commercial audio systems include a fire or an emergency alarm system for building. Other examples include public address systems for buildings. Factories and other places where assembly lines are used often have audio systems that monitor and control process flow of manufacturing assembly line. These monitor and control systems may use signals such as audio signals to indicate when certain events in the manufacturing assembly line need to occur. In addition, these monitor and control systems may signal undesirable conditions along the line.

Some audio systems currently use programmable logic controllers or PLCs to control and monitor the systems. Some PLC outputs may be triggered through high-level graphical user interface (GUI) programming sequences called ladder logic.

Most PLC manufacturers have individual proprietary ladder logic programming instruction sets and programming tools for specific PLCs that they manufacture. A ladder logic programming instruction set is merely a graphical representation of code and is provided for ease in programming the PLC. Once a program is written by an end user it may be downloaded to the PLC and stored in the PLC, from thereon, the PLC's functions may be dictated by running the program.

If a ladder logic system is not used then some other programming suitable system is used.

FIG. 3 is an example of one known audio system 110 using a PLC 112 to control a group of speakers 114-120. In the audio system 110 shown in FIG. 3, the PLC 112 has a power supply and communications area 122 and a plurality of slots 124-136. The first slot 124 has two dry contact outputs in the form of two screws 138 and 140. The dry contact output is where the PLC 112 outputs control signals to an audio tone or voice generator 142 which then provides audio signals to the group of speakers 114-120 in the audio system 110.

The PLC 112 does not directly generate audio signals but rather generates control signals. The audio signals must be generated by an audio tone generator 142. The dry contact screws 138 and 140 are connected to the tone generator 142 by wires 144 and 146. Over the wires 144 and 146, control signals are sent to the audio generator 142 which, in turn, generates audio signals for broadcast by the speakers 114-120.

One drawback of systems incorporating a separate and distinct audio tone generator 142 from the PLC 112 is that these types of systems require an extra piece of hardware. A tone generator 142 is required for the system 110 to perform. Using a separate audio tone generator 142 can make the system 110 bulkier, and less reliable due to the added complexity to the system 110 and makes the system 110 more expensive as it adds to the number of components of the system 110.

Accordingly, it is desirable to provide a system and method for operating an audio system that does not require a separate audio tone generator.

### SUMMARY OF THE INVENTION

The foregoing needs are met, to a great extent, by the present invention, wherein in one aspect an apparatus is provided that in some embodiments an audio system operates and performs without the use of a separate audio generator located between the PLC and the speaker system to generate audio tones for a rebroadcast by speakers within the audio system.

In accordance with one embodiment of the present invention, a programmable logic controller is provided. The programmable logic controller includes a backplane connector connected to the programmable logic controller, an audio generator operably connected to the backplane connector and an output configured to output an audio signal generated by the audio generator.

In accordance with another embodiment of the present invention, a programmable logic controller is provided. The programmable logic controller includes means for generating an audio signal, means for controlling the generating means, means for connecting the generating means to the programmable logic controller, and means for outputting the audio signal wherein the generating means, the controlling means and the connecting means are contained on the programmable logic controller.

In accordance with yet another embodiment of the present invention, a method of generating an audio tone is provided. The method includes interfacing control circuitry with a programmable logic controller and an audio generator generating an audio signal with the audio generator and outputting the audio signal from the programmable logic controller.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic diagram of an audio system according to a preferred embodiment of the invention.

FIG. 2 is a schematic diagram of a programmable logic controller according to a preferred embodiment of the invention.

FIG. 3 is a schematic diagram of an audio system known in the art.

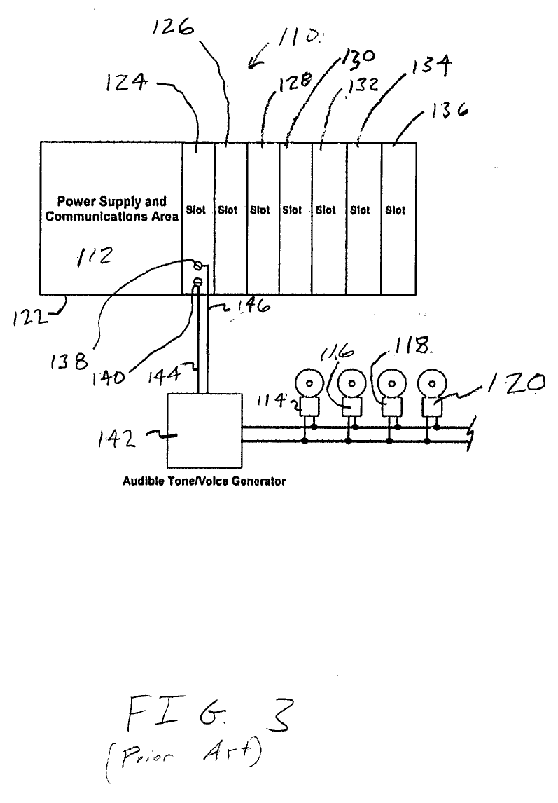

### DETAILED DESCRIPTION

The invention will now be described with reference to the drawing figures, in which like reference numerals refer to like parts throughout. An embodiment in accordance with the present invention provides an audio system that does not require a separate and stand alone tone generator connected between a programmable logic controller (PLC) and a speaker system.

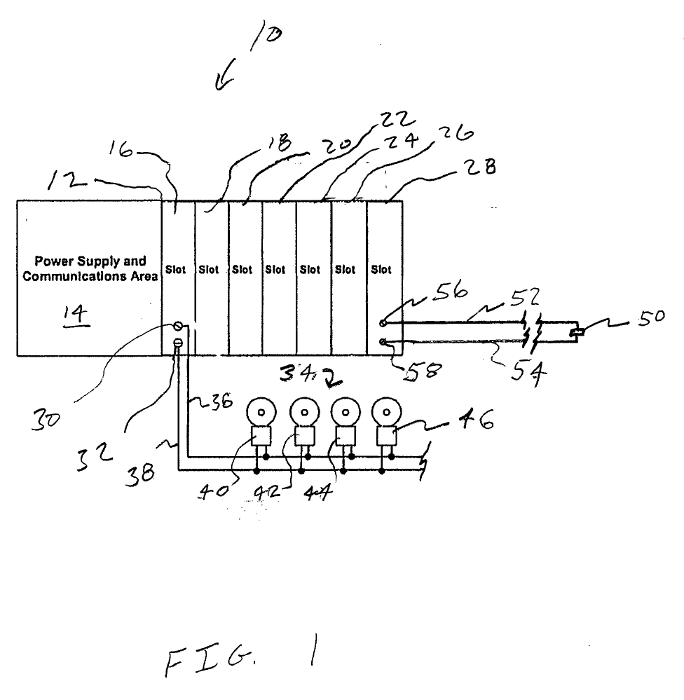

An embodiment of the present inventive apparatus is illustrated in FIG. 1. FIG. 1 shows an audio system 10 including a PLC 12 having a power supply and communications area 14. The PLC 12 has seven slots, 16-28. The slots 16-28 provide outputs or inputs for the PLC 12. The first slot 16, is an output slot. In slot 16, are connecting screws 30 and 32. Connecting screws 30 and 32 connect the PLC 12 to a speaker system 34. The connecting screws 30 and 32 provide a connecting point for the wires 36 and 38. The wires 36 and 38 connect the PLC 12 to the audio speakers 40-46. Other embodiments of the invention may include more or less speakers than the four shown in FIG. 1.

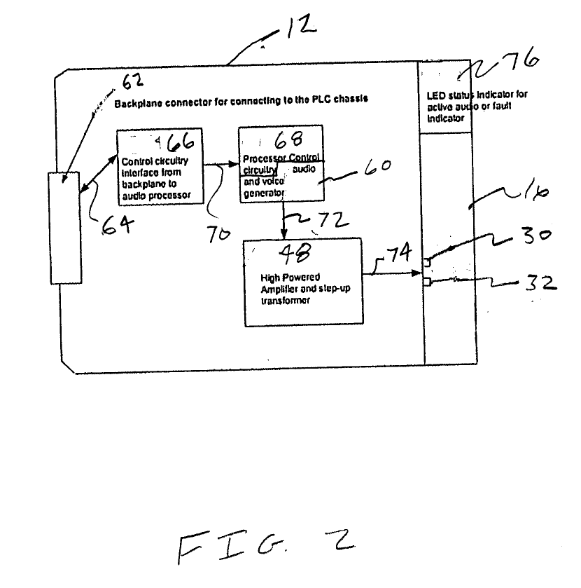

In preferred embodiments of the invention, the PLC 12 will output through slot 16 or whatever slot the speaker system 34 is connected to. In preferred embodiments of the invention, outputs of 1, 10,25, 70.7 or 100 voltage root means squared (Vrms) are sent directly to the speakers 40-46 via an onboard high-power audio amplifier 48 (shown in FIG. 2). Other embodiments of the invention may use output having other Vrms valves. No external tone generator is used.

The speaker system 34 is connected in a loop format by wires 36-38 as shown in FIG. 1. Other embodiments of the invention may permit communication between the speaker system 34 and the PLC 12 through other suitable means, including wireless communication.

In a preferred embodiment of the invention, tone selection and duration is selected directly on board the PLC 12 via ladder logic programming done by the user. In some embodiments of the invention, multiple tone generator modules can be inserted into the PLC system for larger, more complex audio applications. Limitation in the amount of tone modules may depend on the size of the PLC 12 chassis.

In some preferred embodiments of the invention, the PLC 12 may include memory storage for storing voice or other recordings that may be outputted to the speaker system 34 at times that are dictated by the ladder logic program. Other embodiments of the invention may use other types of programs to control the PLC 12 rather than ladder logic type programs.

In some embodiments of the invention, some of the vacant slots such as slots 18-28 may include modules that have sensors that may input data into the PLC 12. For example, in some embodiments of the invention, the PLC 12 may include fire, heat or smoke detecting sensors that, when detecting fire, heat or smoke, input a signal into one of the slots 18-28 in the PLC 12 not occupied by the speaker system 34. And when the sensor inputs a signal detecting smoke, heat, or fire into the PLC 12, the PLC 12 outputs a signal to the speaker system 34 of a fire alarm thus causing the speaker system 34 to play fire alarm tones generated by the PLC 12.

FIG. 1 shows a sensor 50 connected to the PLC in slot 28. The sensor 50 is connected to slot 28 by connectors 52 and 54 connected to connector screws 56 and 58. The sensor 50 is representative of the sensors discussed herein. While the system 10 shown in FIG. 1, has one sensor 50 shown, it is meant to be exemplary and not limiting. The use of multiple sensors is in accordance with the invention.

In other embodiments of the invention, inputs into the vacant slots 18-28 may include industrial parameters such as signals associated with an assembly line. When a fault is detected by one of the sensors along the assembly line, the sensor will then input a signal into its associated PLC slot causing the PLC to generate a tone associated with that fault and outputting a signal to the speaker system to sound a tone associated with the fault detected by the sensor. For example, if an assembly line stopped, a sensor could detect the stoppage and activate a tone associated with a stoppage. Other types of inputs into the PLC may be put into the other vacant slots in the PLC to cause an output to slot connected to the speaker system according to the specific needs and requirements of a specific application.

In a preferred embodiment of the invention, and shown in FIG. 1, the speaker system 34 is connected to the PLC 12 by dry contact screws 30 and 32. However, any other suitable connections may be used in accordance with the invention.

FIG. 2 is block diagram of components comprising a PLC 12 with an integrated tone generator 60. Many PLCs 12 have an interface connector for connecting individual modules to the chassis backplane. As shown in FIG. 2, this connector is a backplane connector 62. The backplane connector 62 provides power and control to the various circuitry blocks onboard the PLC 12 chassis. For example, the backplane connector 62 connects via connection 64 to control circuitry 66. The control circuitry 66 interfaces from the backplane connector 62 the audio processor 68 which includes the tone generator 60. The audio processor 68 is electrically connected by connection 70 to the control circuitry 66. The audio processor 68 contains processor control circuitry for controlling audio and voice generation capability of the tone generator 60.

The control circuitry 66 may vary from manufacturer to manufacturer of the PLC 12. The control circuitry 66 will communicate and store the ladder logic program sequence or other suitable program developed by the end user. The particulars of the program is controlled by the manufacture of the PLC and may differ from manufacturer to manufacturer. The proper commands are controlled and programmed by the use of the system and will vary from system to system.

Once the control circuitry 66 has initiated a process to control and generate an audio or voice signal, that signal is sent by connection 72 to an amplifier 48. Optionally, the audio signal may be a recorded audio tone such as a voice command.

In some embodiments of the invention, the amplifier 48 may be a high-power amplifier and may include a step-up transformer. According to some embodiments of the invention, the amplifier 48 may have a high-power audio output stage. The embodiments of the invention that use an amplifier 48 may include either a class AB or a class D amplifier capable of delivering substantial audio output to be connected to the speaker system 34. Typically, the amplifier 48 may include a step-up transformer capable of producing 1, 10,25,70.7, or 100 Vrms on a secondary output.

Optionally, the high powered amplifier 48 and/or step up transformer may include different output terminals. For example, there may be a different terminal for each output whether it be 1, 10, 25, 70.7, 100 or any other Vrms. Preferably, the outputs will terminate in screw terminals as described, but other output types may be used. Different outputs can be located in different slots 16-28, depending on what slots 16-28 are available.

For example, if the slot being used to operate the speaker system 34 is slot 16, then once the tone signal has been amplified and/or stepped up by the amplifier 48 the amplified signal is sent via connection 74 to the connecting screws 30 and 32 contained within the slot 16.

According to some optional embodiments of the invention, the PLC 12 may also include a status indicator 76 which may indicate whether the PLC 12 and/or speaker system 34 is active or in a fault condition. Examples of faults the indicator 76 could monitor include whether there is a short or grounding within the PLC 12. Other examples include monitoring the speaker loop 34 and wires 36 and 38 shown if FIG. 1. The indicator 76 could indicate whether the speaker loop 34 had a short, was improperly grounded, had a hot wire short, or was not emitting a tone. Different aspects of the PLC 12 or speaker loop 34 could be monitored and shown to be properly working or not depending on the needs and requirements of the individual system.

To assist in the monitoring of the PLC 12 speaker system 34, sensors such as sensor 50 may be incorporated and connected to the PLC 12 to input detected fault conditions.

In some embodiments of the invention, the status indicator 76 may include a LED light which may be green when the system 10 is working properly, or red when the system 10 is at fault.

In some embodiments of the invention, the fault indicator 76 may only light up when a fault condition occurs. Optionally, the fault indicator 76 may emit a fault tone as well as, or instead of, a light.

In some embodiments of the invention, the fault indicator 76 may also indicate if the speaker system 34 is configured incorrectly or if there are other faults caused by improper operation of the system 10 as a whole.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. A programmable logic controller comprising:
a backplane connector connected to the programmable logic controller;
an audio generator operably connected to the backplane connector; and
an output from the programmable logic controller configured to output an audio signal generated by the audio generator.

2. The programmable logic controller of claim 1, further comprising control circuitry interfacing between the backplane connector and the audio generator.

3. The programmable logic controller of claim 1, wherein the output includes screw terminals.

4. The programmable logic controller of claim 1, further comprising an indicator operably connected to the audio generator and configured to indicate whether the audio output is operating correctly or is in a fault condition.

5. The programmable logic controller of claim 1, further comprising a recorder operably connected to the audio generator and configured to have the audio generator output a recorded signal.

6. The programmable logic controller of claim 1, further comprising an amplifier configured to amplify an audio signal generated by the audio generator.

7. The programmable logic controller of claim 1, further comprising a step up transformer configured to increase an audio signal generated by the audio generator.

8. The programmable logic controller of claim 1, wherein the output is configured to output a signal of at least one of about 1, 10, 25, 70.7 and 100 Vrms.

9. The programmable logic controller of claim 1, further comprising a speaker system operably connected to the output.

10. The programmable logic controller of claim 1, further comprising an input configured to input a signal to the programmable logic controller.

11. The programmable logic controller of claim 10, wherein the programmable logic controller is configured to cause the audio generator to generate predetermined signals based on the input signal.

12. The programmable logic controller of claim 10, wherein the signal input to the programmable logic controller associated with a sensor.

13. The programmable logic controller of claim 12, wherein the sensor is configured to sense at least one of fire, heat and smoke.

14. A programmable logic controller comprising:
means for generating an audio signal;
means for controlling the generating means;
means for connecting the generating means to the programmable logic controller; and
means for outputting the audio signal,
wherein the generating means, the controlling means, and the connecting means are contained on the programmable logic controller.

15. The programmable logic controller of claim 14, further comprising means for amplifying the audio signal.

16. The programmable logic controller of claim 14, further comprising means for indicating whether the generating means is functioning or in a fault condition.

17. The programmable logic controller of claim 14, further comprising means for recording an audio tone and causing the audio generating means to output the recorded audio tone.

18. A method of generating an audio tone, comprising the steps of:
interfacing control circuitry with a programmable logic controller and an audio generator;
generating an audio signal with the audio generator; and
outputting the audio signal from the programmable logic controller.

19. The method of claim 18, further comprising the step of amplifying the audio signal.

20. The method of claim 18, further comprising the step of indicating whether the audio generator is functioning.

21. The method of claim 18, further comprising connecting the programmable logic controller to a speaker system.

22. The method of claim 21, wherein the speaker system is connected to the programmable logic controller via screw terminals.

23. The method of claim 18, further comprising inputting an input signal to the programmable logic controller and generating an audio signal associated with the input signal.

24. The method of claim 18, further comprising recording an audio signal on to the programmable logic controller and outputting the recorded signal.
